(19) United States
(12) Patent Application Publication
(10) Pub. No.: US 2023/0244955 A1
(43) Pub. Date: Aug. 3, 2023

(54) Decision Diagram-Based Management of a Computer System or its Part

(71) Applicant: Mirela Grujic, Belgrade (RS)

(72) Inventor: Mirela Grujic, Belgrade (RS)

(73) Assignee: Mirela Grujic, Belgrade (RS)

(21) Appl. No.: 17/649,500

(22) Filed: Jan. 31, 2022

(51) Int. Cl. G06N 5/02

(52) U.S. Cl. CPC G06N 5/02

(57) ABSTRACT

A system and a method for the management of a computer system or its part are provided. The method includes receiving a request, wherein the request represents an input for a deterministic finite state machine model of the computer system or its part; determining the next state by traversing a decision diagram that represents the transition relation of the finite state machine; determining whether at least a function is associated with the transition, and executing the associated functions, if any, to change the state and/or configuration of the computer system or its part.

### BACKGROUND OF THE INVENTION

For a computer system to satisfy performance, energy, thermal, security, real-time, and/or base operational requirements, there may exist a need to coordinate and control the states and configurations of hardware and software components in the system at runtime. The coordination and control are performed by a management system. The management system may be implemented in software and executed on a dedicated processor and/or across multiple processors in the same computer system. Some exemplary computer systems include a microcontroller, a system-on-a-chip, a heterogeneous multiprocessor system-on-a-chip, a server, and others.

The management system in many computer systems is part of an operating system. However, there exist computer systems that do not include an operating system or that complement the existing management system of an operating system with another one. Other computer systems may include a complex software stack comprising a firmware, a hypervisor, multiple operating systems, real-time operating systems, or bare-metal applications, wherein an existing management system of an operating system no longer has comprehensive information about the requirements, such as real-time or base operational requirements, to manage the whole computer system. Nevertheless, it may be beneficial to replace an existing management system with a better one.

In practice, the management system for a particular computer system is typically implemented by using a programming language, such as C or C++. The coordination and control of the states and configurations of hardware and software components in the state-of-the-art are commonly implemented directly in a programming language, often without any use of formal models to represent and analyze the system behavior prior to the implementation. With the growing number of hardware and software components and the complexity of computer systems in general, it is becoming advantageous to use formal models and methods in the development of management systems. For example, a formal model could be used for formal verification, such as model checking, and simulation purposes prior to the implementation. It would be beneficial if a formal model of the system, which may be used for verification and simulation purposes, could be used for the implementation of the management system.

If a formal model is used for the implementation of a management system, it would be favorable to make use of, possibly existing, software parts that implement the configuration or state control for a particular hardware or software component. For example, software that highly depends on hardware architecture and interfaces of other software, such as powering down a processor, may be better implemented by a skilled engineer than a tool. In this case, a formal model would not need to be detailed. However, it would be advantageous to make use of the formal model for solving common challenges in the state-of-the-art, such as ensuring a correct sequencing and timely execution of software that implements state and control of individual hardware and software components.

Another challenge in the state-of-the-art is predicting effects, such as response time and energy savings, at runtime, before configuring a state. For example, it would be advantageous to estimate at runtime, before making the transition, the energy-saving benefit of transiting into a low-power state and the response time penalty of exiting the low power state. Depending on the energy and real-time requirements, the increased response time may be tolerable only for higher energy savings or may not be tolerated at all. It would be favorable for the management system to include information required to make such estimates, for example by using a compact data structure because the management system often has a relatively small amount of memory available for its operations.

The decision diagram is a data structure commonly used for an internal representation of finite state machines in model checkers that are used for formal verification. Some model checkers may output the decision diagram of a verified model. To determine next states of a finite state machine, model checkers typically perform operations on the decision diagram or may search the decision diagram, which is impractical for a runtime management system as significant processing time and memory resources may be required. It could be advantageous if a management system would make use of the decision diagram, but only if the next state can be determined without requiring significant processing time and memory resources.

### SUMMARY OF THE INVENTION

To address the above challenges and other shortcomings within the art, a method and a system for the management of a computer system or its part is provided. The system includes the reduced and ordered binary decision diagram to represent the transition relation of a deterministic finite state machine model of at least one system component, wherein the system component is a hardware, software, or a combined hardware-software part of the computer system.

This invention provides a method for traversing the reduced and ordered binary decision diagram to determine the next state, wherein the finite state machine is deterministic and variables in the decision diagram are ordered such that input and current-state variables precede next-state variables of the transition relation function. The values of input and current-state variables are known at runtime and represented by a path in the decision diagram which is traversed first. The next state is determined by continuing the traversal along the path and following edges that do not end at the zero-terminal node.

The method for the management of a computer system or its part includes receiving a request, wherein the request represents an input for a deterministic finite state machine model of the computer system or its part; determining the next state by traversing a decision diagram that represents the transition relation of the finite state machine; determining whether at least one function is associated with the transition, and executing the associated functions, if any, to change the state and/or configuration of the computer system or its part.

It should be noted that this Summary of the Invention is provided to introduce a selection of concepts in a simplified form that are further described below in the Detailed Description of the Invention. This Summary of the Invention is not intended to identify key features or essential features of the claimed subject matter, nor is it intended to be used to limit the scope of the claimed subject matter.

### BRIEF DESCRIPTION OF DRAWINGS

The various advantages of the embodiments of the present invention will become apparent to one skilled in the art by reading the following specification and appended claims, and by referencing the accompanying drawings. In the drawings:

FIG. 1 is a simplified block diagram of a decision diagram-based system for the management of a computer system or its part according to an embodiment;

FIG. 2 is an example of a decision diagram, specifically the reduced and ordered binary decision diagram, representing an example of the transition relation of a finite state machine;

FIG. 3 is a flowchart illustrating a method for the decision diagram-based management of a computer system or its part according to an embodiment;

FIG. 4 is a simplified block diagram of another decision diagram-based system for the management of a computer system or its part according to some embodiments.

### DETAILED DESCRIPTION OF THE INVENTION

Certain features of embodiments, which are described in the context of separate embodiments, may also be provided in combination in a single embodiment. Conversely, various features of embodiments, which are described in the context of a single embodiment, may also be provided as suitable in any other described embodiment.

It will be understood by one of ordinary skill in the art that a system and a method presented herein may be adopted and modified as is appropriate for the computer system being managed, and that a system and a method described herein may be employed in other suitable application, and that such other additions and modifications will fall within the spirit and broad scope of the appended claims.

In general, unless otherwise indicated, singular elements presented herein may be in plural and vice versa with no loss of generality. For example, the current-state variables of the transition relation function of a finite state machine may be in singular if the finite state machine has only two states.

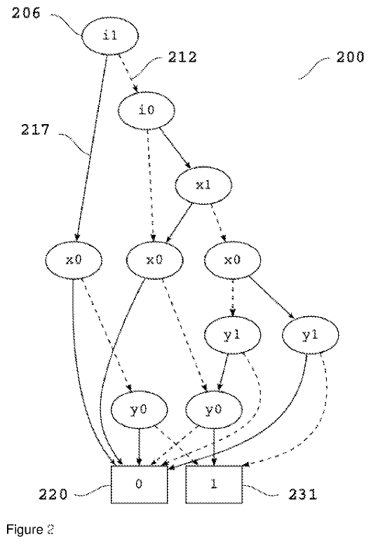

Some examples of the present disclosure are given to introduce the reader to the general subject matter discussed herein and are not intended to limit the scope of the disclosed invention. For example, although the transition relation of a finite state machine is represented by the binary decision diagram, as is shown in FIG. 2, other decision diagrams may also be used if a system and a method described herein are adopted and modified as is appropriate.

Unless otherwise defined, all scientific and technical terms and notations used herein have the same meaning as commonly understood by one of ordinary skill in the art.

For brevity, herein the term “system component” is used to mean a software component, a hardware component, or a combined software-hardware component, wherein the component is a part of a computer system.

Examples of a software component include, but are not limited to, a firmware, a bootloader, a device driver, a thread, a process, an operating system kernel, a real-time operating system, a microkernel, a hypervisor, a virtual machine, a part or combinations thereof, and the like. Examples of a hardware component include, but are not limited to, a processor, a multi-core processor, a processing subsystem comprising processors, a coprocessor, an accelerator, a microcontroller, a memory, an interconnect, an on-chip controller, an I/O peripheral, a PLL (phase-locked loop), a power domain, and the like. An example of a combined software-hardware component is a processor executing an operating system.

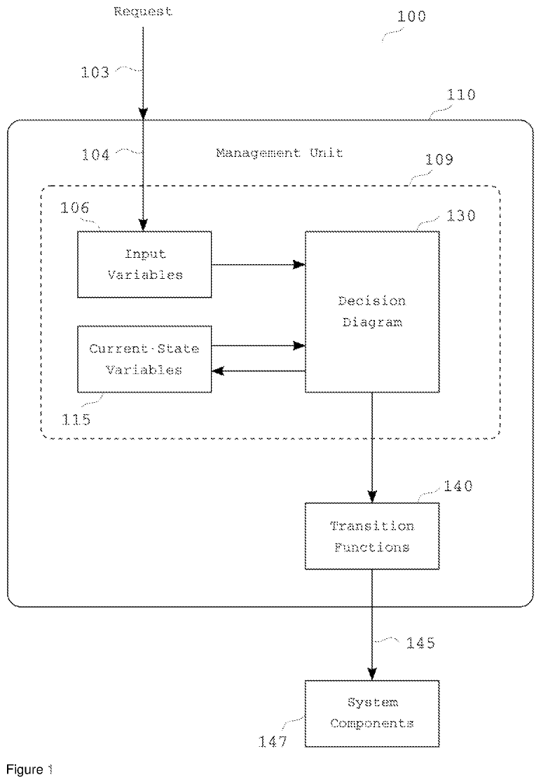

FIG. 1 illustrates an example block diagram of a management system, wherein the management system 100 includes a single management unit 110 according to an embodiment. The management unit 110 includes a decision diagram 130, wherein the decision diagram 130 represents the transition relation of a deterministic finite state machine, wherein the finite state machine models at least one system component 147 (FIG. 1 depicts a plurality of system components). The system components 147 are subject to the management 145 of the management unit 110. In FIG. 1 the finite state machine is represented by 109.

The management unit 110 can receive a request 103, wherein the request can be, but is not limited to, a system call, an API call, an interrupt service routine, and the like. The management unit 110 determines whether the received request represents an input for the finite state machine, wherein the input is represented by the values of input variables 106, wherein the input variables are variables of the transition relation function of the finite state machine. For example, the management unit 110 may include a map of requests and values of input variables, wherein the received request represents an input if there exists a mapping of the request to the values of input variables. If determined so, the management unit 110 updates input variables 106, as shown in FIG. 1 with 104. Optionally, the management unit may acknowledge the reception of the request by, but not limiting to, returning a value, issuing an API call, writing to a register or memory location, and the others.

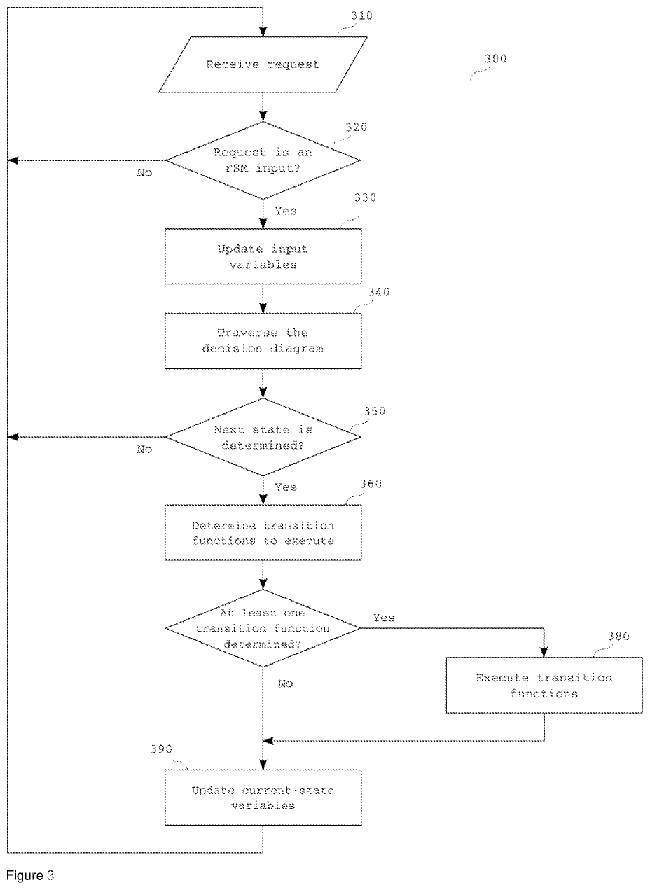

The current state of the finite state machine is represented by the values of current-state variables 115, wherein the current-state variables are variables of the transition relation function of the finite state machine. The management unit 110 updates current-state variables 115 at runtime as further discussed herein below with reference to FIG. 3.

In some embodiments, initial values of input variables, such as 106, and current-state variables, such as 115, are predetermined (known before the runtime). In other embodiments, the initial value of at least one input or current-state variable may be determined at runtime during the initialization of the management unit 110, by, but not limiting to, receiving requests, querying current states of target system components, loading configuration data, combinations thereof, and the like.

When the management unit 110 determines that the received request represents an input for the finite state machine, the management unit 110 traverses the decision diagram 130 to determine the next state for the finite state machine, as is discussed in detail herein below with reference to FIG. 2. It should be noted that, when the finite state machine does not react to the received input in its current state, the next state will not be determined by the management unit.

In an embodiment, after determining the next state, the management unit 110 determines whether at least one function from 140 is associated with the transition, wherein the transition can be identified by the values of current-state and next-state variables. If determined that the association exists, the management unit 110 executes the associated functions from 140, wherein the function can be, but is not limited to, a procedure call, a remote procedure call, an instruction, write to a register or a memory location, a system call, a plurality and/or combinations thereof, and the like. Executing an associated function may result in the change of the state and/or configuration of at least one system component from 147.

In FIG. 2 is shown an example of the decision diagram 130 from FIG. 1, specifically, the reduced and ordered binary decision diagram 200. The decision diagram 200 represents the transition relation of a deterministic finite state machine, wherein the transition relation and the number and naming of variables represent a simplified, particular case that is selected for illustration purposes and to provide an example to the reader.

Excluding the zero-terminal node 220 and the one-terminal node 231, each node in the decision diagram 200 is associated with an input variable, a current-state variable, or a next-state variable, wherein the input, current-state, and next-state variables are variables of the transition relation function of the finite state machine. In FIG. 2 as an example, the association is illustrated by the naming of nodes, specifically, i0 and i1 denote input variables, x0 and x1 denote current-state variables, and y0 and y1 denote next-state variables.

A path in the binary decision diagram that connects the root node 206 with the zero-terminal node 220 or the one-terminal node 231 represents an evaluation of the transition relation, wherein the transition relation evaluates to true if the path ends at the one-terminal node 231, or it evaluates to false if the path ends at the zero-terminal node 220. A dashed outgoing edge of a node in FIG. 2, such as 212, denotes that the variable associated with the node takes value false, and a solid outgoing edge of a node in FIG. 2, such as 217, denotes that the variable associated with the node takes the value true.

A path in the binary decision diagram that connects the root node 206 with the one-terminal node 231 represents a transition of the finite state machine. Since the finite state machine herein is deterministic, there exists a single next state to which the machine can transit from its current state upon reacting to input.

In an embodiment, the variables in the binary decision diagram are ordered so that input and current-state variables precede next-state variables. With such an ordering in place, the input and current-state variables are traversed before next-state variables, wherein the traversal starts from the root node 206.

The binary decision diagram is traversed by the management unit 110 to determine the next state. If the machine is reactive to the received input in its current state there exists a path in the decision diagram that represents the current values of input and current-state variables. The values of next-state variables are determined by traversing the binary decision diagram along the path and following edges that do not end at the zero-terminal node 220.

FIG. 3 shows an example flowchart 300 of an operation of a management unit according to an embodiment, wherein the management unit includes elements as 110 shown in FIG. 1. At 310, the management unit receives a request, wherein the request may represent an input for the finite state machine included in the management unit.

At 320, the management unit determines whether the received request represents an input for the finite state machine. If the request represents an input for the finite state machine, the management unit at 330 updates input variables to the values representing the input, otherwise, processing of the received request completes, and the management unit is ready to process another request.

After updating at least one input variable at 330, the management unit at 340 traverses the decision diagram to determine the next state, as described herein above with reference to FIG. 2. If the finite state machine is reactive to the received input in its current state, the decision diagram traversal at 340 results in the values of next-state variables, and then at 350, the next state is considered determined. Otherwise, processing of the received request completes at 350.

When the next state is determined, the management unit at 360 determines whether at least one function is associated with the transition, and executes the associated functions (transition functions), if any, at 380. At 390, the management unit updates the values of current-state variables to match the values of next-state variables, and the transition to the next state is considered completed.

In an embodiment, the current-state variables may be updated before the transition functions are executed, wherein compared to the operation flow shown in FIG. 3 the step 390 precedes step 380.

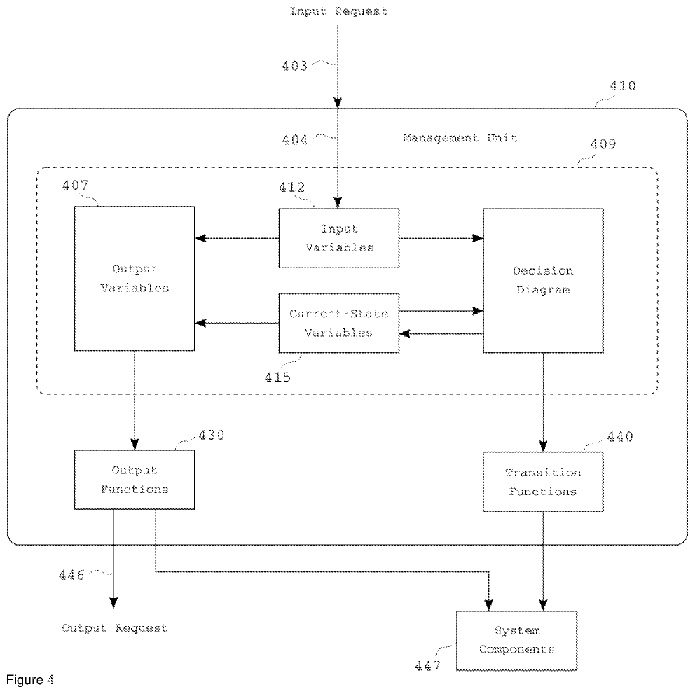

FIG. 4 shows an example block diagram of a management unit 410 according to some embodiments, wherein compared with the finite state machine 109 from the FIG. 1 the finite state machine represented by 409 can produce at least one output, wherein the output is represented by the values of output variables 407. An output variable from 407 can be a function of current-state variables 415 or a function of input 412 and current-state variables 415, wherein the function may be represented by a decision diagram according to an embodiment (not shown in FIG. 4). After at least one input or current-state variable changes the value, the management unit 410 evaluates all output variables from 407, according to an embodiment. In another embodiment, the management unit 410 may evaluate only some output variables from 407, wherein the output variables are functions of the changed current-state and/or input variables.

When an output variable changes value, the management unit 410 determines which functions from 430 shall be executed, if any. If determined so, the management unit 410 executes the functions from 430, wherein the function can be, but is not limited to, a procedure call, a remote procedure call, an instruction, write to a register or a memory location, a system call, and the like, and a plurality and/or combinations thereof. Executing the function may generate an output request 446, or change the state or configuration of at least one system component 447, or combination thereof, wherein the output request may be served by the same management unit or one or a plurality of other management units in the management system.

In an embodiment, a management unit may include a plurality of finite state machines 109. In another embodiment, a management unit may include a plurality of finite state machines, wherein each of the finite state machines produces at least one output as is described in one of the embodiments herein above. In some embodiments, a management unit includes at least one finite state machine that does not produce an output, such as 109, and at least one finite state machine that produces at least one output as is described in one of the embodiments herein above. It should be understood that the current-state and input variables of a finite state machine are associated with a decision diagram that represents the transition relation of the same finite state machine.

According to an embodiment, the current-state and input variables of at least two finite state machines may be associated with a single decision diagram if transition relations of the finite state machines can be represented by decision diagrams that are isomorphic graphs.

In some embodiments, transitions of at least one finite state machine may not be associated with transition functions, such as 140 or 440. For example, this may be the case when a finite state machine produces at least one output, wherein the output may be used for input/output communication between finite state machines.

In an embodiment, a management system comprises a plurality of management units, wherein the management units may, but do not have to, mutually communicate using input/output requests.

According to an embodiment, a management unit is implemented in software and executed on a processing unit, wherein the processing unit can be, but is not limited to a processor, a multi-core processor, a coprocessor, a microcontroller, an exception level of a processor, and the like. In an embodiment, the execution of a management system comprising a plurality of management units may be distributed across several processing units, wherein a plurality of management units may be executed on the same processing unit.

In an implementation, the variables, such as input, current-state, next-state, and output variables, may be represented by using variables in a programming language such as C or C++, according to an embodiment. A decision diagram, for example, may be represented by using at least one data structure (called the unique table in the state-of-the-art). Associations of functions and values of variables may, but do not have to be implemented by using a dictionary.

In an embodiment, execution of at least one management unit can be migrated at runtime at least once from one processing unit to another, wherein the migration comprises one processing unit sharing the management unit data to the other processing unit, wherein management unit data includes at least current values of input and current-state variables, and sharing data may include, but is not limiting to, writing back the data from the cache to main memory accessible by another processing unit, copying data into memory or registers accessible by another processing unit, sending data over a communication channel, and others.

In an embodiment, at least one management unit includes a decision diagram that has some or all nodes and/or edges annotated with additional information. For example, the nodes associated with current-state variables may be annotated with values representing power consumption, and for example, by summing power consumption values that annotate nodes along a path in the decision diagram, the power consumption of system components in a state may be estimated at runtime. As another example, nodes associated with next-state variables may be annotated with values representing time, wherein the values may be used to predict the response time to an input request.

In some embodiments, a management unit may include an input buffer, for example between 103 and 104 from FIG. 1 (not shown) or between 403 and 404 from FIG. 4 (not shown), to store information about the received inputs, wherein information is stored if the management unit decides to postpone the processing of input and does not update input variables immediately. For example, information about a received input may be represented by using values of input variables. The decision to postpone the processing may be made for a subset of inputs, wherein the decision for a specific input may be always made or may be made considering also the current state, next state, or results of the computation performed on the values that annotate nodes in the decision diagram, wherein the values annotate the nodes in the decision diagram according to the embodiment described above, and the like.

When the management unit postpones processing an input, the management unit schedules a timeout. After scheduling a timeout and before the timeout expires, the management unit may receive another input and decide to dismiss the postponed processing of input from the buffer, wherein the timeout scheduled for the dismissed input is canceled. Otherwise, when the timeout expires, the management unit continues the postponed processing as described in the embodiment above. It should be understood that the management unit may start processing at least one other request while waiting for the timeout to expire, and that a notification about an expired timeout may be received as any other request, wherein the request represents an input for a finite state machine included in the same management unit.

As an example, the management unit may decide to postpone the processing of an input, wherein processing the input causes a hardware component to enter a low-power state. Later processing of another input may cause the same hardware component to switch to the previous state. If the period time between receiving two inputs is commonly relatively short, it may be beneficial to wait for some time before entering the low-power state, and thus avoid the toggling of states.

It should be understood that the management unit may postpone processing of only a subset of inputs because some other inputs always require immediate processing. The management unit includes additional information to determine whether the processing of input shall be postponed, the value of timeout to be scheduled for the input or a function to compute the timeout value, and a subset of inputs that shall dismiss the postponed processing of the input.

The flowchart and block diagrams in the Figures and accompanying descriptions disclosed above illustrate the architecture and operation of possible implementations of systems and methods according to various embodiments. In this regard, blocks in the flowchart or block diagrams may represent a software module, a function in a programming language, a collection of data, and the like. In some alternative implementations, blocks may occur out of the order noted in the flowchart, if the operation flow of the management system still correctly coordinates and controls the states and configurations of system components. For example, the management unit may update current-state variables prior to executing a transition function. In some alternative implementations, blocks in block diagrams may not be logical entities as illustrated in the figures. For example, input and current-state variables may not be separated into two distinct blocks as is illustrated in the figures. It should be noted that the execution of functions to change the state and/or configuration of a system component is assumed to be sequential in the presented embodiments, although in some alternative implementations the execution of functions may be in parallel, or some functions may be executed sequentially and other functions in parallel.

1. A system for the management of a computer system or its part, the system comprising:
at least one decision diagram, wherein each decision diagram represents the transition relation of a deterministic finite state machine model of at least one system component, wherein the variables in the decision diagram are ordered so that input and current-state variables precede next-state variables;
data representation of input and current-state variables of transition relations, wherein transition relations are represented by decision diagrams;
at least one function to be executed to change the state and/or configuration of at least one system component;
at least one computer program to at least: receive requests, map received requests to the values of input variables, update input and current-state variables, traverse the decision diagram to determine the next state, map the values of current-state and next-state variables to functions, and execute functions to change the state and/or configuration of a computer system or its part upon updating current-state variables;
at least one processing unit to execute the computer program.

2. A system of claim 1, further comprising:
annotations of nodes and/or edges of at least one decision diagram, wherein annotations represent additional information associated with nodes and/or edges.

3. A system of claim 1, further comprising:
at least one input buffer to store information about received requests, wherein received requests are postponed for later processing;
at least one timer to schedule timeouts;
software functions and data for postponed processing of received requests, canceling timeouts, and dismissing requests.

4. A system of claim 1, further comprising:
data representation of output variables, wherein output variables represent outputs of finite state machines;
at least one function to update values of output variables;
at least one function to generate output requests.

5. A method for the management of a computer system or its part, the method comprising:
representing at least one transition relation of a deterministic finite state machine model of at least one system component using at least one binary decision diagram, wherein the variables in the decision diagram are ordered so that input and current-state variables precede next-state variables;
representing input and current-state variables of transition relations by using program variables, wherein the input and current-state variables are initialized before the management unit receives the first request;
receiving a request;
determining whether the received request represents an input for the finite state machine, and if so, determining at least one value and updating at least one input variable, otherwise completing the processing of received request;
determining the next state by traversing the decision diagram, wherein the values of input and current-state variables are known, and wherein the values of next-state variables are determined by following a path in the decision diagram that does not lead to the zero-terminal node;
determining if one or multiple functions are associated with the transition to the next state, and executing the associated functions, if any, wherein the execution of a function results in the change of state and/or configuration of at least one system component;
updating values of current-state variables.

6. The method of claim 5, further comprising:
representing outputs of at least one finite state machine by using output variables;
computing values of output variables upon taking the transition, and assigning computed values to output variables;
determining if one or multiple functions should be executed upon assigning a value to an output variable, and executing the associated functions, if any, wherein the execution of a function results in the change of state and/or configuration of at least one system component or in generating an output request.

7. The method of claim 5, further comprising:
analyzing received requests and at least one decision diagram to determine whether the received request should be postponed;
postponing a received request and scheduling a timeout, if determined so;
receiving another request and canceling the postponed processing and corresponding scheduled timeout, or receiving notification of timer expiration and processing the postponed request.

8. The method of claim 5, further comprising:
migrating the management of the computer system or its part from one processing unit to another.
